(19) United States
(12) Patent Application Publication
(10) Pub. No.: US 2012/0049562 A1
(43) Pub. Date: Mar. 1, 2012

(54) Sun Shade With Clinging Surface

(75) Inventors: Christopher David Mowder, Topeka, KS (US); Brent H. Windsor, Emporia, KS (US)

(73) Assignee: HOPKINS MANUFACTURING CORPORATION, Emporia, KS (US)

(21) Appl. No.: 12/870,058

(22) Filed: Aug. 27, 2010

(51) Int. Cl. B60J 3/00

(52) U.S. Cl. 296/97.6

(57) ABSTRACT

An automotive sun shade including a solid loop member (see DEFINITIONS section) and a pliable shade member. The solid loop member defines at least an open position, and the open position of the solid loop member defines an interior area. The solid loop member acts as a frame that supports the pliable shade member. The pliable shade member is mechanically connected to the solid loop member so that it covers at least a substantial portion of the interior area when the solid loop member is in the open position. The pliable shade member is sufficiently opaque and sufficiently large in area to act as an automotive sun shade. The pliable sun shade includes a “clinging surface” (see DEFINITIONS section). The clinging surface has a sufficient area and clinging ability so that the sun shade can, at least partially and preferably totally, supported against gravitational by clinging force between the clinging surface and the a window of a motor vehicle (for example, a wind shield or a side window).

### BACKGROUND OF THE INVENTION

1. Field of the Invention

The present invention relates to shades for windows and more particularly to automotive sun shades for placing over vehicle windows to block sunlight from coming into the vehicle and heating it up (especially when the vehicle is parked).

2. Description of the Related Art

There are many types of conventional automotive sun shades.

One type is shown in US patent application 2004/0231809 (“Wheatley”). The Wheatley sun shade is in the form of a thin, pliable sheet that is partially opaque, but has translucent portions and/or openings. The Wheatley thin sheet style sun shade has a clinging surface that will cling to a vehicle window “in a frictional manner.” The clinging surface is disclosed to be made of polyvinyl chloride (PVC), partially cured PVC, expanded vinyl or polyurethane. Wheatley further discloses that its sheet of material can include a thin layer of polyurethane, or a thin polyurethane coating. The Wheatley sheet is apparently intended to remain on the vehicle for a relatively long term, including periods when the vehicle is driven, and/or its window is rolled up and down. Wheatley does disclose that its sheet can be removed for washing and put back into place after washing. (See Wheatley at paragraph 0029.)

Another conventional style of sun shades incorporates a frame in the form of one or more loops of somewhat resilient material, where the frame supports a panel of pliable material such a fabric. Herein, these will be called “loop style sun shades.” Some loop style sun shades can have their loops folded upon themselves in various ways so that the shade can be folded down to a smaller area when it is not in use over a vehicle window. Herein, this subset of loop style sun shades will be called “folding loop style sun shades.” Examples of loop style sun shades are disclosed in: (i) U.S. Pat. No. 4,815,784 (“784 Zheng”); and (ii) U.S. Pat. No. 5,213,147 (“147 Zheng”).

Description of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

Before moving to the present invention, there will be a brief explanation of disadvantages of the Wheatley sun shade which may or may not have been recognized and/or recognized as disadvantages. The Wheatley sun shade is believed to be relatively difficult to work with because it is in the form of a large area floppy sheet. Wheatley recommends against folding its sun sheet in any manner that would form folds or creases. (See, Wheatley at paragraph 0032.) From a user's perspective, this would seriously compound the difficulty in dealing with the Wheatley sun shade because not only is the user dealing with a large area floppy sheet, but the user is dealing with a large area floppy sheet that cannot be folded up like a map. Also, because Wheatley is thin, and particularly because it is thin around its edges, Wheatley is most likely susceptible to tearing, and particularly to tears starting at its peripheral edges. At least the automotive application's of the Wheatley sun shade must be not be substantially opaque or ideally opaque. (See, Wheatley at paragraph 005 and herein at DEFINITIONS section). Now, these potential disadvantages may not be disadvantages in the contexts in which the Wheatley sun shade is intended to be used. It appears that Wheatley is intended to stay on the vehicle for relatively long periods of time, and to be left in place when the vehicle is driven. However, the Wheatley sun shade is likely to be unsuitable for use a sun shade that is put into place only when the vehicle is parked in direct sunlight, and taken down from the window when the vehicle is driven. This kind of sporadic use, if applied to the Wheatley style shade, would greatly increase the frequency of gently manipulating something that is relatively difficult to manipulate. Unfortunately, many sun shades are intended for sporadic, parking-only use because: (i) they can be used on a windshield; and (ii) they can be made very opaque and/or reflective because the driver does not need to be able to see through it.

The present invention is directed to a sun shade including a solid loop member (see DEFINITIONS section) and a pliable shade member (see DEFINITIONS section). The solid loop member defines at least an open position, and the open position of the solid loop member defines an interior area. The solid loop member acts as a frame that supports the pliable shade member. The pliable shade member is mechanically connected to the solid loop member so that it covers at least a substantial portion of the interior area when the solid loop member is in the open position. The pliable shade member is sufficiently opaque and sufficiently large in area to act as an automotive sun shade. The pliable sun shade includes a “clinging surface” (see DEFINITIONS section).

Preferably, the clinging surface has a sufficient area and clinging ability so that the sun shade can be supported against gravitational by clinging force between the clinging surface and the a window of a motor vehicle (for example, a wind shield or a side window). In some (not necessarily preferred) embodiments, the sun shade will include supplemental attachment hardware, such as straps or suction cups, where the supplemental attachment hardware is structured and located to help hold the sun shade in place on a motor vehicle window against gravity by providing support in addition to the support that is provided by the clinging force of the clinging surface.

Preferably, the pliable shade member is “substantially opaque” (see DEFINITIONS section). In some embodiments of the present invention, the sun shade may be “ideally opaque” (see DEFINITIONS section), but this is not necessarily preferred. Preferably, the pliable shade member includes a thin, pliable polymer layer, including the clinging surface. In some embodiments, the thin, pliable layer will provide at least a substantial degree of opacity to the pliable shade member. In some embodiments, the pliable shade member will consist only of the pliable polymer layer. In other embodiments, the pliable shade member will include both a thin, polymer layer and a fabric layer. In some preferred embodiments of the pliable shade member, its thin, pliable polymer layer will be substantially translucent and its fabric layer will be at least substantially opaque. In these embodiments where the pliable shade member includes a polymer layer and a fabric layer: (i) the polymer layer preferably provides the clinging surface; (ii) the fabric layer preferably adds opacity; (iii) the fabric layer preferably adds mechanical strength and resistance against tearing or creasing of the polymer layer; (iv) the fabric layer and the polymer layer may or may not have co-extensive area(s); and (v) the fabric layer and the polymer layer may or may not be directly attached to each other. For example, regarding item (v), the fabric and polymer layers may each be held in place by the respective mechanical connections to the solid loop.

Preferably, the solid loop is sufficiently resilient so that it can be folded and unfolded between the open position and at least one relatively stable folded position. The geometry of the folded position may be any loop folding geometry now known or to be developed in the future. In one preferred embodiment, a substantially rectangular (in the open position) resilient loop may be folded into three substantially circular sections (in a first folded position). In some embodiments, the sun shade further includes a loop shape strap which is preferably: (i) mechanically connected to the rest of the sun shade; (ii) elastic; and (iii) sized to hold the sun shade in at least one folded configuration.

Preferably, the sun shade further includes a pliable binding strip shaped and located so that it is folded around at least a portion of the solid loop to form opposing surfaces that: (i) extend into the interior area of the solid loop; and (ii) are each mechanically connected to the pliable shade member. The attachment between the opposing surfaces of the pliable binding strip and the pliable shade member is preferably by stitching, but any other type of mechanical connection (for example, adhesive, thermosetting), now known or to be developed in the future is possible. In other embodiments of the present invention, the binding strip could be omitted. For example, a portion of the pliable shade member could be folded around and sewn onto the solid loop to form the mechanical connection between the solid loop and the pliable shade member. As a further example, adhesive or thermosetting could be used to mechanically connect the pliable shade member to the solid loop in a relatively direct manner.

The sun shade may have more than one solid loop. For example, a large sheet of pliable shade member may extend across and around multiple solid loops to connect these loops to each other. 784 Zheng shows an example of this, albeit without the clinging surface of the present invention.

Various embodiments of the present invention may exhibit one or more of the following objects, features and/or advantages:

(i) a sun shade that reliably stays in place in a window and especially in the window of a motor vehicle;

(ii) a sun shade that is easy to handle in an open position;

(iii) a sun shade that can be easily folded/unfolded between an open position and a folded position for easily switching the shade between a position in place in a window and a stored position away from the window (this is especially helpful in sun shade applications where an automotive sun shade is only used when the vehicle is parked, thereby requiring frequent switching in and out of the sun shade);

(iv) a sun shade that is easy to stick into place into a car window by merely gently pushing a clinging surface into place, in contact with a major surface of the window;

(v) a sun shade with a clinging surface that is well-protected from tearing and creasing when it is folded or otherwise manipulated; and

(vi) a sun shade that leaves little or no space between a window (for example a windshield) and the shade member because of clinging engagement between the sun shade and the window (this lack of space between the shade an window can help prevent heat build up that occurs with shades that do leave a space between the sun shade and the window).

According to one aspect of the present invention, a sun shade includes: a solid loop member which defines at least an open position and further defines an interior area when the solid loop member is in the open position; and a pliable shade member. The pliable shade member and solid loop member are mechanically connected to each other so that the pliable shade member covers at least a substantial portion of the interior area when the solid loop member is in the open position. The pliable shade member is sufficiently large in coverage and sufficiently opaque to act as a sun shade. The pliable sun shade comprises a clinging surface that can help detachably attach the sun shade to a window against gravitational forces by clinging force.

According to a further aspect of the present invention, an automotive sun shade includes: a first solid loop member defines at least an open position and further defines a first interior area when the first solid loop member is in its open position; a second solid loop member defines at least an open position and further defines a second interior area when the second solid loop member is in its open position; and a pliable shade member. The pliable shade member and first solid loop member are mechanically connected to each other so that the pliable shade member covers at least a substantial portion of the first interior area when the first solid loop member is in the open position. The pliable shade member and second solid loop member are mechanically connected to each other so that the pliable shade member covers at least a substantial portion of the second interior area when the second solid loop member is in the open position. The pliable shade member effectively mechanically connects the first solid loop to the second solid loop. The pliable shade member is sufficiently large in coverage and sufficiently opaque to act as an automotive sun shade. The pliable sun shade comprises a clinging surface that can help detachably attach the sun shade to a window against gravitational forces by clinging force.

According to a further aspect of the present invention, a sunshade includes: a pliable shade member; and a frame member. The pliable shade member and frame member are mechanically connected to each other so that the frame member extends at least partially around an outer edge of the pliable shade member. The pliable shade member is sufficiently large in coverage and sufficiently opaque to act as a sun shade. A clinging surface that can help detachably attach the sun shade to a window against gravitational forces by clinging force is located on one of the following: the pliable shade member, or the frame member.

### BRIEF DESCRIPTION OF THE DRAWINGS

The present invention will be more fully understood and appreciated by reading the following Detailed Description in conjunction with the accompanying drawings, in which:

FIG. 1 is an orthogonal front view of a first embodiment of a clinging sun shade according to the present invention;

FIG. 2 shows the first embodiment sun shade in place, clinging to the inside of the windshield of an automobile;

FIG. 3 is a cross-sectional view (cross hatching lines omitted for clarity) of the first embodiment sun shade (note: the Figures are not generally to any exact scale, but the thicknesses and the relative thicknesses of FIG. 3 are especially exaggerated for clarity of illustration);

FIG. 4 is a close up view of a portion of the cross-section shown in FIG. 3;

FIG. 5 is an orthogonal top view of the first embodiment sun shade in a folded position;

FIG. 6 is an orthogonal side view of the first embodiment sun shade in the folded position; and

FIG. 7 is an orthogonal front view of a second embodiment of a clinging sun shade according to the present invention.

### DETAILED DESCRIPTION OF THE INVENTION

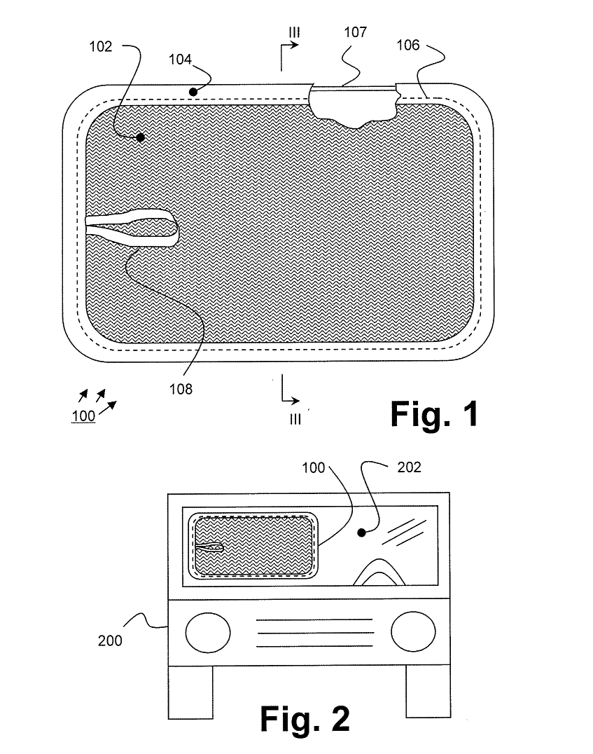

FIGS. 1 and 3-6 show automotive sun shade 100 according to the present invention, shade 100 including: polymer layer 101; pliable binding strip 104; stitching 106; resilient metal loop 107; elastic strap 108; and fabric layer 110. FIG. 2 shows the sun shade in place on the interior side of windshield 202 of automobile 200. Sun shade 100 blocks and/or reflects incoming sunlight from coming into the passenger cabin of the automobile and heating it up. Because sun shade 100 is substantially opaque (see DEFINITIONS section), it is not meant to be left in place when automobile 200 is driven. Rather, sunshade 100 is meant to be put into place when the automobile is parked in a sunny location, and taken out of the window when the automobile is to be driven. This means that sun shade 100 is preferably designed to be handled and manipulated a lot, as will be further explained below.

FIGS. 1 and 2 show sun shade 100 in its open position. Some (not necessarily preferred) embodiments of the present invention have only an open position. In the open position, the sun shade is generally flat and planar. Although the shape of sun shade 100 is rectangular with rounded corners, other shapes are possible. Sun shade 100 is mounted in an automobile, or other, window 202 by pressing clinging surface 102 (shown by stipling in FIG. 1) of polymer layer gently against the surface of the window. Because surface 102 is a clinging surface, it will cling, by clinging force, to the window. This clinging force between the clinging surface and the surface of the window serves to hold sun shade 100 in position on window 202. Alternatively, other supplemental attachment hardware, such as straps or hooks or hook-and-loop fastener material or suction cups could be additionally present. It is noted that the action of pressing sun shade 100 onto the surface of the window is an extremely easy to perform action and helps make the sun shade quick and easy to use. Because sun shade 100 attached to the window by clinging force over a large surface area, there is little or no space between the facing major surfaces of the shade and the window. This is advantageous because it prevents heat generation and/or build up in this space by eliminating the space.

Sun shade 100 is removed from the window by grabbing binding 106 and loop 107 at one or more location and gently pulling the shade off of the window. Even though the clinging force is enough to hold the sun shade in place on the window, this clinging force can be overcome just by gentle pulling. The loop and/or binding provide leverage, control and mechanical strength at the peripheral edge of the shade when removing the sun shade so that the fragile polymer layer is not torn.

Sun shade 100 can be manipulated between the open position of FIGS. 1 and 2 and a closed position shown in FIGS. 5 and 6. In the closed position, the user manipulates loop 107 (through binding 104) to take the form of three generally circular loops stacked on top of each other. The actual twisting that the loop goes is fairly geometrically complex, but is somehow surprisingly intuitive to the user. While the rectangle with rounded corners shape that folds into three circular loops is a preferred folding pattern, other folding patterns are possible, both now known (for example, in automotive sun shades that do not have clinging surfaces) and to be developed in the future. The resilience, cross-sectional shape and proportions of loop 107 is what allows it to be folded. While a metal loop is preferred, other materials are possible.

The polymer layer 101 and fabric layer 110 (collectively called a sun shade member) will now be discussed. As mentioned above, polymer layer 101 provides the clinging surface. The polymer layer may be made of any polymer susceptible to be formed as a thin sheet and capable of providing a clinging surface including, but not necessarily limited to: polyvinyl chloride (PVC), partially cured PVC, expanded vinyl and/or polyurethane. Alternatively, the polymer layer may not be polymer at all, but, rather any material that can provide a clinging surface, as now known or to be developed in the future. In this preferred embodiment, polymer layer 101 is translucent, but it may also be made opaque in order to help block out the sunlight. In some embodiments, there may be only a polymer layer and no fabric layer (but this is not necessarily preferred for reasons to be discussed below). In other embodiments there may be additional layers, such as, for example, a light reflective layer. In still other embodiments, there may be clinging surfaces on both major surfaces of the shade (for example, using multiple polymer layers) so that a user can press either side to a window, without being concerned that the “wrong” major surface of the shade is facing the window.

In many preferred embodiments, the polymer layer will be thin, and made of inexpensive material, which can result in a polymer layer that is susceptible to punctures and tears and creases. However, in many embodiments (for example, ones where the polymer layer does not extend beyond the solid loop), the mechanical strength of the solid loop and or binding will protect the otherwise vulnerable peripheral edge from tearing. Also, the solid loop and/or binding provides a good grabbing and holding surface for users, which reduces user manipulation of the polymer layer itself, which, in turn, reduces punctures of tears caused by user manipulation of the shade. Still further, the mechanical connection between the polymer layer and the solid loop (such as the indirect mechanical connection formed by the binding and stitching in shade embodiment 100), will generally mean that the polymer layer is held somewhat taut, at least in the open position. Of course, too much tautness could lead to stretching, weakening and tearing of the polymer layer and is not preferred. However, a limited amount of tautness can help prevent and/or smooth creasing.

In shade 100, the fabric layer provides most of the opacity, and also mechanical strength over the major surfaces of the shade. For example, a user's finger that might otherwise poke through the polymer layer in the direction normal to the major surface can be stopped by the strength of the fabric layer. As a further example, if a user grabs and two portions of the major surface inside of the binding and pulls them apart, then the fabric may absorb and/or stop the tension-causing force to rip the polymer layer. Fabric layer 110 is preferably moderately elastic. While fabric layer 110 preferably provides substantial opacity (that it, one would not drive with the shade in place over the driver's side window of the motor vehicle), the fabric may be able to be see thru somewhat. For example, the fabric may be a nylon mesh that can be seen through about as well as through fabric of a typical woman's stocking. Alternatively, the fabric may be more opaque and more densely woven or matted. As a further alternative the fabric layer may be replaced with something else entirely, like a mylar film. Whatever material is chosen for the fabric layer (if any), the layer should preferably be light in weight enough that the clinging surface alone can hold the shade up against gravity by its clinging force.

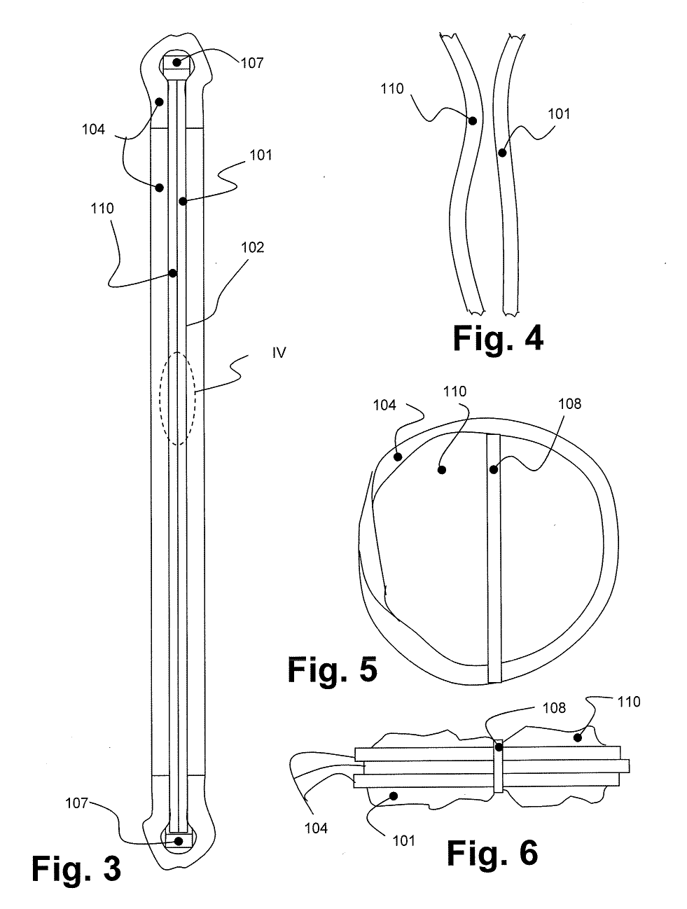

While polymer layer 101 and fabric layer 110 form a laminate structure, as shown in FIG. 3, they are not necessarily directly mechanically connected to each other. As shown in FIG. 4, polymer layer 101 and fabric layer 110 are preferably not connected to each other along their facing major surfaces. Alternatively, the polymer layer and the fabric layer (and/or other layers) could be joined to each other over part or all of their mutually facing major surfaces.

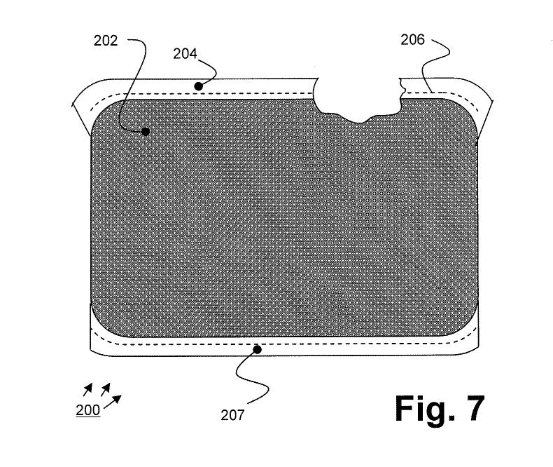

FIGS. 1 and 3 show the metal loop 107 and how binding 108 is folded around the metal loop so that it forms a generally U-shape with opposing surfaces that face each other across the peripheral edge of the pliable shade member. As shown in FIG. 1, stitching is preferably used to mechanically connect the binding to the peripheral edge of the pliable shade member in this vicinity. FIG. 7 shows sunshade 200 including: non-clingy sunshade member 202; first frame member 204; adhesive seam location 206; and second frame member 207. In this embodiment, sunshade member 202 is not clingy, but frame members 204, 207 are clingy and can fully support the sunscreen in place in a vehicle window against gravitational forces. In this embodiment the frame member is mechanically connected to the sunshade member by adhesive. In some preferred embodiments, the sunshade is characterized as a “rear window only sunshade, is substantially completely opaque. In sunshade 200, frame members 204, 207 are pliable, but they can: (i) be of any degree of flexibility between freely pliable and ideally rigid; and (ii) have any degree or type of resiliency, such as brittle, non-resiliently bendable, resiliently bendable or elastic. Alternatively, sunshade member 202 could be clingy and frame members 204, 207 could be non-clingy.

### DEFINITIONS

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

Embodiment: a machine, manufacture, system, method, process and/or composition that may (not must) meet the embodiment of a present, past or future patent claim based on this patent document; for example, an “embodiment” might not be covered by any claims filed with this patent document, but described as an “embodiment” to show the scope of the invention and indicate that it might (or might not) covered in a later arising claim (for example, an amended claim, a continuation application claim, a divisional application claim, a reissue application claim, a re-examination proceeding claim, an interference count); also, an embodiment that is indeed covered by claims filed with this patent document might cease to be covered by claim amendments made during prosecution.

First, second, third, etc. (“ordinals”): Unless otherwise noted, ordinals only serve to distinguish or identify (e.g., various members of a group); the mere use of ordinals shall not be taken to necessarily imply order (for example, time order, space order).

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, slidable mechanical connections; mechanical connectors that form a chemical connection; frictional connections; and/or static electricity based connections.

Substantially opaque: any shade not permitting enough visibility to allow for safe driving when placed over the side windows of an automobile.

Ideally opaque: letting through substantially no visible light.

Solid loop member: includes solid loop members that are: of any shape, including (bit not limited to) any polygons; constant in cross section and/or cross-sectional shape around the loop; not constant in cross section and/or cross-sectional shape around the loop; made of a single piece or unitary; not unitary; formed with pieces extraneous to the loop (such as a rigid carrying handle); foldable; not foldable; relatively flexible; relatively inflexible; relatively resilient; relatively non-resilient; relatively rigid; relatively elastic; of substantially uniform rigidity/elasticity; and/or not of substantially uniform rigidity/elasticity.

clinging surface/clinging force: refers to clinging that results from: (i) presence of plasticizers, (ii) electric charge, (iii) elasticity (for example, elasticity from coiling and uncoiling of cross-linked polymers), and/or (iv) a combination of these factors; includes, but is not limited to, hydrophilic clinging surfaces and hydrophobic clinging surfaces; although clinging surfaces will usually include some sort of polymer, this is not necessarily required.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

1-4. (canceled)

5. A sun shade comprising:
a solid loop member which defines at least an open position and further defines an interior area when the solid loop member is in the open position; and
a pliable shade member comprising a first major surface, a second major surface and a peripheral edge;
wherein:
the peripheral edge of the pliable shade member and solid loop member are mechanically connected to each other so that the pliable shade member covers at least a substantial portion of the interior area when the solid loop member is in the open position;
the pliable shade member is sufficiently large in coverage and sufficiently opaque to act as a sun shade; and
the first major surface of the pliable shade member is a clinging surface that can help detachably attach the sun shade to a window against gravitational forces by clinging force.

6. The sun shade of claim 5 wherein the clinging surface is sufficiently large in area and clinging ability so that it can detachably attach the sun shade to a window against gravitational forces by clinging force without additional forms of mechanical support.

7. The sun shade of claim 5 wherein the clinging surface comprises polymer material.

8. The sun shade of claim 7 wherein the sun shade comprises at least one of the following: polyvinyl chloride (PVC), partially cured PVC, expanded vinyl, and/or polyurethane.

9. The sun shade of claim 5 wherein the pliable sun shade member is at least substantially opaque.

10. The sun shade of claim 5 wherein the pliable shade member is sufficiently large in coverage and sufficiently opaque to act as an automotive sun shade.

11. The sun shade of claim 5 wherein the solid loop member is shaped, is proportioned and is sufficiently resilient so that it can be folded between the open position and at least a first folded position.

12. The sun shade of claim 11 wherein the solid loop member is shaped, is proportioned and is sufficiently resilient so that: (i) it has a rectangular shape with rounded corners when it in the open position, and (ii) it has the shape of a stack of three generally circular rounds when it is in the first folded position.

13. The sun shade of claim 5 further comprising a flat, pliable binding strip, wherein:
the pliable binding strip is located so that it is folded around at least a portion of the solid loop member so that the binding strip will have two opposing surfaces that extend into the interior area when the solid loop member is in the open position; and
the opposing surfaces of the binding strip are mechanically connected to at least a portion of a peripheral edge of the pliable shade member to make the mechanical connection between the solid loop member and the pliable shade member.

14. The sun shade of claim 13 wherein the flat pliable binding strip is made of nylon fabric.

15. The sun shade of claim 13 wherein the opposing surfaces of the flat pliable binding strip are mechanically connected to the pliable shade member by stitching.

16. The sun shade of claim 5 wherein the pliable shade member comprises a polymer layer, wherein the polymer layer provides the clinging surface.

17. The sun shade of claim 16 wherein the pliable shade member further comprises a fabric layer.

18. The sun shade of claim 17 wherein:
the fabric layer is substantially opaque; and
the polymer layer is translucent.

19-20. (canceled)
